(19) United States
(12) Patent Application Publication
(10) Pub. No.: US 2022/0284394 A1
(43) Pub. Date: Sep. 8, 2022

(54) TRANSPORTATION PLANNING SYSTEM AND TRANSPORTATION PLANNING METHOD

(71) Applicant: Hitachi, Ltd., Tokyo (JP)

(72) Inventors: Akane SETO, Tokyo (JP); Kazuya UYAMA, Tokyo (JP); Junko HOSODA, Tokyo (JP); Naoko KISHIKAWA, Tokyo (JP)

(73) Assignee: Hitachi, Ltd., Tokyo (JP)

(21) Appl. No.: 17/683,745

(22) Filed: Mar. 1, 2022

(30) Foreign Application Priority Data
Mar. 2, 2021 (JP) 2021-032553

(51) Int. Cl. G06Q 10/08

(52) U.S. Cl. CPC G06Q 10/08345; G06Q 10/0835

(57) ABSTRACT

A transportation planning system includes a control section and a storage section. The storage section retains cargo information, vehicle information, location information, movement time period information, and storage location information. The control section divides a region including a plurality of locations into a plurality of divisional regions, selects one or more of the locations as a candidate for a storage location of cargo, and generates a plurality of transportation schedules each including the candidate for a storage location and a storage period. The control section determines that, in a case where an amount of cargo to be stored does not exceed the capacity of the storage location, the plan of the candidate for is reasonable, and calculates a transportation cost in one or more of the transportation schedules for which it has been determined that the plan of the candidate storage is reasonable.

### CLAIM OF PRIORITY

The present application claims priority from Japanese patent application JP 2021-32553 filed on Mar. 2, 2021, the content of which is hereby incorporated by reference into this application.

### BACKGROUND OF THE INVENTION

### 1. Field of the Invention

The present invention relates to a technology for making a transportation plan.

### 2. Description of the Related Art

As a technology for making a transportation plan having a cargo relay, a technology disclosed in JP-2009-223552-A (Patent Document 1) is available. The document has a description: “a freight logistics cost optimization method having a relay point, characterized in that the transportation cost is minimized and evaluated.”

### SUMMARY OF THE INVENTION

A transportation company that collects cargos in a factory and delivers the cargos to a dealer temporarily stores, in a warehouse, cargos whose period from collection to delivery is long. Therefore, it is necessary to determine a transportation schedule including a plan of a storage place and period of each cargo. Further, implementing transportation incurs usage fees of transportation resources such as a vehicle cost, a labor cost for drivers and so forth, and a storage cost for storage. The transportation company preferably makes a transportation schedule that minimizes the transportation cost calculated as the sum total of such costs.

In Patent Document 1, the storage place is fixed in a certain period of a planning target. Therefore, if the cargo amount fluctuates, then the loading rate of an arranged vehicle is low on a day when the cargo amount is small, resulting in a disadvantage that an unnecessary vehicle cost is required.

Therefore, it is an object of the present invention to provide a technology for making a transportation schedule including a plan, for example a daily plan, for a storage place and period of each of cargos for a period designated by a user such that the transportation cost is reduced within the capacity of storage places and transportation resources.

According to an aspect of the present invention, there is provided a transportation planning system including a control section and a storage section connected to the control section. The storage section retains cargo information indicative of a transportation source, a transportation destination, and a transportation amount of cargos based on an order, vehicle information indicative of a loading capacity and a cost of each of a plurality of vehicles that can be used for transportation of the cargos, location information indicative of positions of a plurality of locations at each of which at least one of loading of the cargos into the vehicles, unloading of the cargos from the vehicles, and storage of the cargos is to be performed, movement time period information indicative of a time period required for movement between the locations, and storage location information indicative of an amount of cargos that can be stored and a storage cost at each of locations at which the cargos can be stored among the plurality of locations. The control section divides a region including the plurality of locations into a plurality of divisional regions each including one or more of the locations, selects one or more of the locations in each of the plurality of divisional regions as a candidate or candidates for a storage location of the cargos, and generates a plurality of transportation schedules each including a plan of the candidate or candidates for a storage location and of a storage period for storing each of the cargos on the basis of the cargo information, the vehicle information, the location information, and the movement time period information. The control section further determines, on the basis of the storage location information, that, in a case where an amount of cargos to be stored at the candidate or candidates for a storage location of the cargos in each of the plurality of transportation schedules does not exceed the amount of cargos that can be stored at the corresponding location, the plan of the candidate or candidates for a storage location and of the storage period included in the transportation schedule is reasonable, and calculates a transportation cost in one or more of the transportation schedules for which it has been determined that the plan of the candidate or candidates for a storage location and of the storage period is reasonable, on the basis of the vehicle information, the location information, the movement time period information, and the storage location information.

According to one aspect of the present invention, the transportation cost can be reduced in transportation including a cargo that requires temporary storage from collection to delivery. The subjects, configurations, and advantageous effects other than those described above are made clear by the following description of embodiments.

### BRIEF DESCRIPTION OF THE DRAWINGS

FIG. 1 is a block diagram depicting an example of a configuration of a transportation planning system and an example of a functional configuration of a transportation planning apparatus according to a working example 1;

FIG. 2 is a block diagram depicting an example of a hardware configuration of the transportation planning apparatus according to the working example 1;

FIG. 3 is a flow chart depicting an example of a transportation planning process according to the working example 1;

FIG. 4 is a view depicting an example of a data structure of cargo information according to the working example 1;

FIG. 5 is a view depicting an example of a data structure of vehicle information according to the working example 1;

FIG. 6 is a view depicting an example of a data structure of location information according to the working example 1;

FIG. 7 is a view depicting an example of a data structure of berth information according to the working example 1;

FIG. 8 is a view depicting an example of a data structure of movement cost information according to the working example 1;

FIG. 9 is a view depicting an example of a data structure of storage location information according to the working example 1;

FIG. 10 is a view depicting an example of a data structure of storage place proposal information according to the working example 1;

FIG. 11 is a view depicting an example of a data structure of plan proposal information according to the working example 1;

FIG. 12 is a flow chart illustrating an example of a plan evaluation process performed by a plan evaluation section according to the working example 1;

FIG. 13 is a view depicting an example of a display screen image of a transportation schedule result overview of vehicles displayed on a display device of the transportation planning apparatus according to the working example 1;

FIG. 14 is a view depicting an example of a display screen image of a transportation schedule result overview of cargos displayed on the display device of the transportation planning apparatus according to the working example 1;

FIG. 15 is a view depicting an example of a display screen image of an in-vehicle terminal according to the working example 1;

FIG. 16 is a view depicting an example of a display screen image of a plan management terminal at each location according to the working example 1;

FIG. 17 is a view depicting an example of a data structure of driver information according to a working example 2; and

FIG. 18 is a view depicting an example of a data structure of worker information according to the working example 2.

### DESCRIPTION OF THE PREFERRED EMBODIMENTS

In the following, embodiments of the present invention are described with reference to the accompanying drawings. In the embodiments, identical elements are denoted by identical reference symbols in principle, and overlapping description of them is omitted. It is to be noted that the embodiments are mere examples for implementing the present invention and do not restrict the technological scope of the present invention.

### WORKING EXAMPLE 1

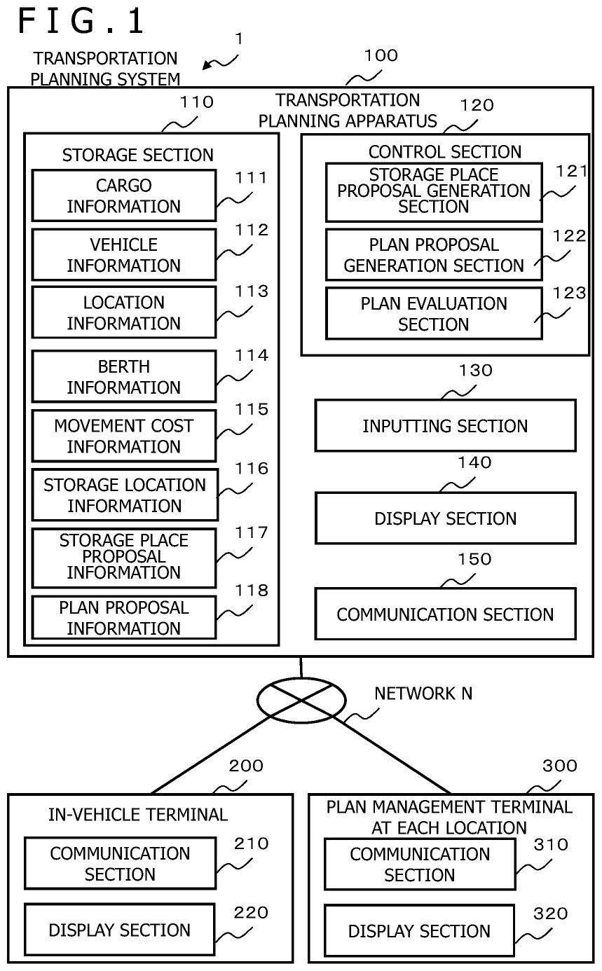

FIG. 1 is a block diagram depicting an example of a configuration of a transportation planning system 1 and an example of a functional configuration of a transportation planning apparatus 100 according to a working example 1.

The transportation planning system 1 includes the transportation planning apparatus 100, and an in-vehicle terminal 200 and a plan management terminal 300 at each location which are connected for communication to the transportation planning apparatus 100 through a network N.

The transportation planning apparatus 100 includes a storage section 110, a control section 120, an inputting section 130, a display section 140, and a communication section 150.

The storage section 110 stores therein cargo information 111, vehicle information 112, location information 113, berth information 114, movement cost information 115, storage location information 116, storage place proposal information 117, and plan proposal information 118.

The cargo information 111 is information of cargos to be transported. The vehicle information 112 is information of vehicles arranged already at the time of planning and vehicles which can be additionally arranged. The location information 113 is information of locations of a factory and so forth. The berth information 114 is information of berths at the locations. The movement cost information 115 is information that defines the cost required for movement between two locations. The storage location information 116 is information of locations having cargo storage equipment (namely, locations capable of storing cargos) among locations included in the location information 113. The storage place proposal information 117 is information of storage place proposals generated by the control section 120. The plan proposal information 118 is information of transportation schedule proposals generated by the control section 120.

The control section 120 includes a storage place proposal generation section 121, a plan proposal generation section 122, and a plan evaluation section 123. The storage place proposal generation section 121 generates storage place proposals for individual cargos by using the cargo information 111, the vehicle information 112, the location information 113, the movement cost information 115, and the storage location information 116, and stores the storage place proposals for the cargos into the storage place proposal information 117.

The plan proposal generation section 122 generates transportation schedule proposals for storing cargos once at the storage places designated by the storage place proposals, by using the cargo information 111, the vehicle information 112, the location information 113, the berth information 114, the movement cost information 115, the storage location information 116, and the generated storage place proposals, and stores the transportation schedule proposals into the plan proposal information 118. The plan evaluation section 123 stores as an optimum proposal a proposal that indicates the lowest transportation cost among the transportation schedule proposals for which the transportation cost has been calculated.

The inputting section 130 accepts an inputting operation made by a user.

The display section 140 displays the transportation schedules planned by the control section 120 on a display device.

The communication section 150 transmits or receives information to or from the in-vehicle terminal 200 and the plan management terminals 300 at the individual locations.

The in-vehicle terminal 200 is mounted on each transportation vehicle. In the in-vehicle terminal 200, a communication section 210 receives a transportation schedule for each transportation vehicle transmitted thereto from the communication section 150, and a display section 220 displays the received transportation schedule.

The plan management terminal 300 is arranged at each of the locations. In the plan management terminal 300, a communication section 310 receives a transportation schedule transmitted thereto from the communication section 150, and a display section 320 displays the received transportation schedule.

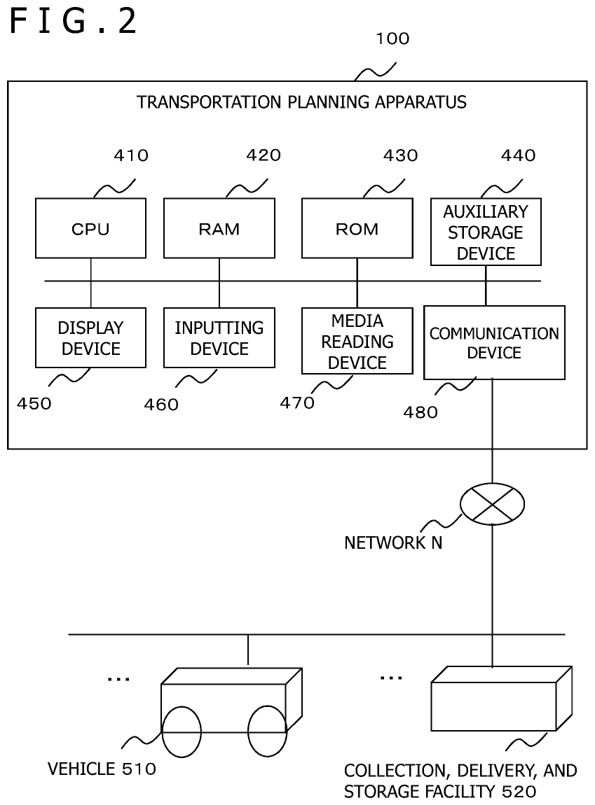

FIG. 2 is a block diagram depicting an example of a hardware configuration of the transportation planning system 1 according to the working example 1.

The transportation planning apparatus 100 includes a central processing unit (CPU) 410, a random access memory (RAM) 420, a read only memory (ROM) 430, an auxiliary storage device 440, a display device 450, an inputting device 460, a media reading device 470, and a communication device 480. The transportation planning apparatus 100 is capable of transmitting and receiving information to and from the in-vehicle terminal 200 (not depicted in FIG. 2) mounted on a vehicle 510 and the plan management terminal 300 (not depicted in FIG. 2) arranged in a collection, delivery, and storage facility 520, through the communication device 480.

The CPU 410 executes various arithmetic operations. The RAM 420 is a memory for storing a program to be executed by the CPU 410, data, and so forth. The ROM 430 is a memory for storing a program necessary for start-up of the transportation planning system and so forth. The auxiliary storage device 440 is a device such as a hard disk drive (HDD). The display device 450 is a device such as a liquid crystal display. The inputting device 460 is a device, such as a keyboard, which is used by the user to input information to the transportation planning apparatus 100. The media reading device 470 is a device for reading information from a portable storage medium such as a universal serial bus (USB) memory. The communication device 480 transmits or receives information to or from an external device through the network N.

For example, the control section 120 depicted in FIG. 1 is a function of the CPU 410, and the storage section 110 is a function of the RAM 420, the ROM 430, and the auxiliary storage device 440. For example, information stored in the storage section 110 depicted in FIG. 1 is stored in the RAM 420 and so forth. Further, functions of the components in the control section 120 are implemented by the CPU 410 executing programs stored in the RAM 420 and so forth. Further, the inputting section 130 depicted in FIG. 1 is a function of the inputting device 460, the display section 140 is a function of the display device 450, and the communication section 150 is a function of the communication device 480.

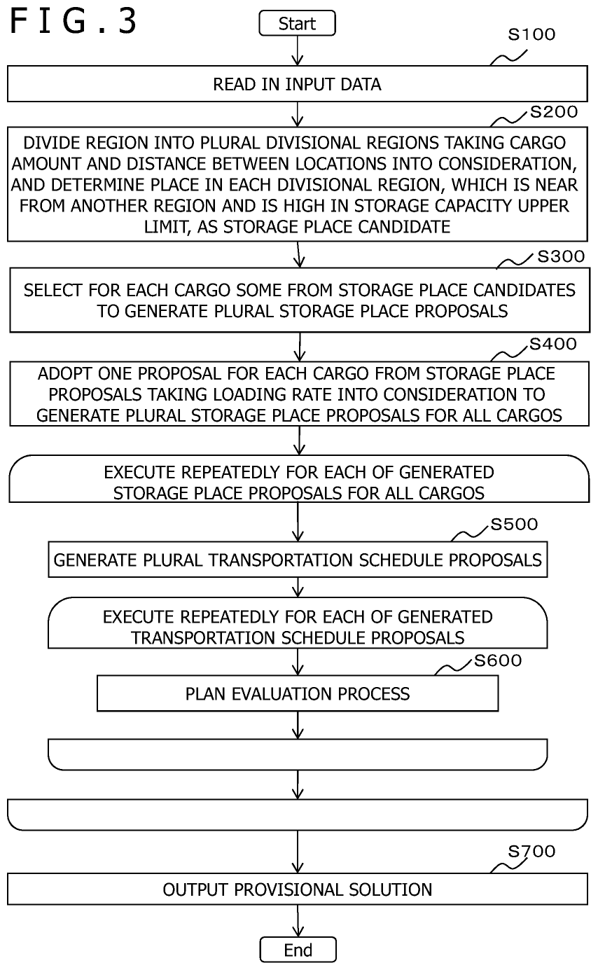

FIG. 3 is a flow chart depicting an example of a transportation planning process according to the working example 1.

The transportation planning process is started, for example, when the inputting section 130 accepts an input. After the process is started, the transportation planning apparatus 100 reads input data from the in-vehicle terminal 200, the plan management terminals 300 at the locations, and the inputting device 460 into the storage section 110 (step S100).

Then, the storage place proposal generation section 121 divides an entire region including all locations that become a target of transportation planning into a plurality of divisional regions, taking the cargo amount to be collected and delivered at each of the locations recorded in the location information 113 and distances between the locations into consideration. Then, the storage place proposal generation section 121 determines, in each of the divisional regions, storage locations each of which is short in distance to another divisional region and is high in storage capacity upper limit, as storage place candidates in the plan (step S200).

Then, the storage place proposal generation section 121 selects, for each cargo, storage place candidates from the storage place candidates determined in step S200 to generate a plurality of storage place proposals (S300).

Then, the storage place proposal generation section 121 adopts one proposal for each cargo from the storage place proposals selected at step S300, taking the loading rate into consideration, to generate a plurality of storage place proposals for all cargos and places the storage place proposals into the storage place proposal information 117 (step S400).

Thereafter, the transportation planning apparatus 100 carries out processing in steps S500 to S600 for all of the generated storage place proposals.

In particular, in step S500, the plan proposal generation section 122 generates a plurality of transportation schedule proposals for transporting the cargos such that each of the cargos is temporarily stored at the storage place designated by the storage place proposal, by using only transportation resources and facilities that can be used, and places the transportation schedule proposals into the plan proposal information 118.

Thereafter, the plan evaluation section 123 carries out processing in step S600 in accordance with all of the generated transportation schedule proposals.

In particular, in step S600, the plan evaluation section 123 performs a plan evaluation process. The plan evaluation process is a process of evaluating the transportation schedule proposals and storing a provisional transportation schedule (hereinafter referred to also as a provisional solution).

Finally, in step S700, the transportation planning apparatus 100 outputs the provisional solutions to the display section 140. Further, the communication section 150 transmits the transportation schedules to the in-vehicle terminal 200 and the plan management terminals 300 at the locations through the network N.

In the following, processing in the steps of FIG. 3 is described.

In step S100, the storage section 110 reads the cargo information 111, the vehicle information 112, the location information 113, the movement cost information 115, and the storage location information 116 from the inputting device 460. The storage section 110 may further read the berth information 114.

FIG. 4 is a view depicting an example of a data structure of the cargo information 111 according to the working example 1.

The cargo information 111 includes, as items, at least “order number” for identifying an order, “collection source code” indicative of a collection source, “delivery destination code” indicative of a delivery destination, “quantity” indicative of the number of cargos, “collection date and time” indicative of date and time when collection is possible, and “delivery date and time” indicative of date and time when delivery is possible. The “quantity” may be substituted by “weight” indicative of a total weight of the cargos, “volume” indicative of a total volume of the cargos, a partial combination of “quantity,” “weight,” and “volume,” or a “cargo amount” indicative of an amount of the cargos. Each of the “collection date and time” and the “delivery date and time” may have “start” indicative of starting date and time of a period during which collection or delivery is possible and “end” indicative of ending date and time of the period during which collection or delivery is possible.

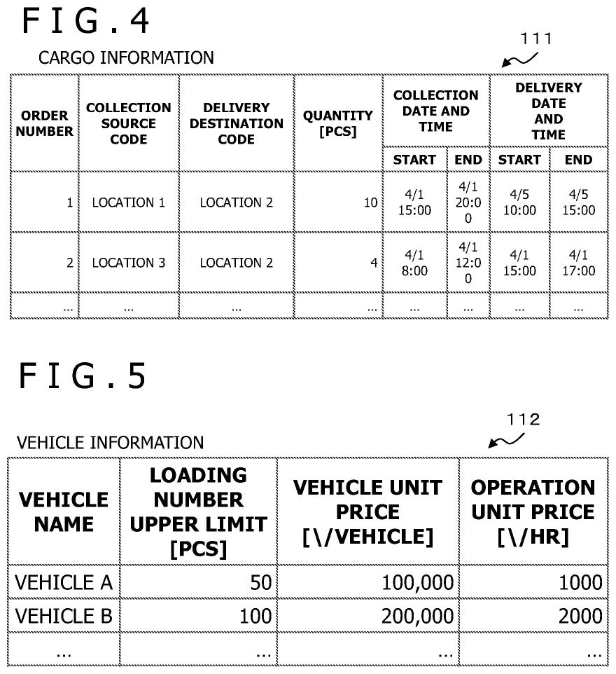

FIG. 5 is a view depicting an example of a data structure of the vehicle information 112 according to the working example 1.

The vehicle information 112 includes at least “vehicle name” for identifying a vehicle, “loading number upper limit” indicative of a loading number upper limit of the vehicle, “vehicle unit price” indicative of an arrangement fee required for one vehicle, and “operation unit price” indicative of a fee required for a vehicle operating time unit. The “loading number upper limit” may be substituted, for example, by “loading weight upper limit” indicative of a loading weight upper limit of the vehicle, a “loading volume upper limit” indicative of a loading volume upper limit of the vehicle, a partial combination of “loading number upper limit,” “loading weight upper limit,” and “loading volume upper limit,” or a “loadable amount upper limit” indicative of a loadable amount upper limit of the vehicle.

Further, though not depicted in FIG. 5, the vehicle information 112 may further include information indicative of an upper limit of the operating time per one day of each vehicle.

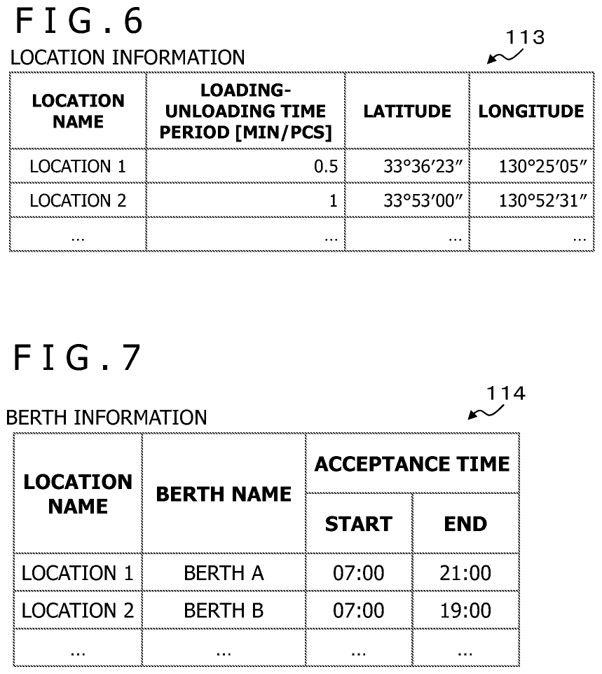

FIG. 6 is a view depicting an example of a data structure of the location information 113 according to the working example 1.

The location information 113 includes at least “location name” for identifying a location and “loading-unloading time period” indicative of a unit time period in which loading or unloading is performed at the location. The location information 113 may further include information for specifying the position of the location, for example, “latitude” indicative of a latitude of the location and “longitude” indicative of a longitude of the location.

FIG. 7 is a view depicting an example of a data structure of the berth information 114 according to the working example 1.

The berth information 114 includes at least “location name” for identifying a location, “berth name” for identifying a berth at the location, and “acceptance time” indicative of time when the berth can accept a vehicle. The “acceptance time” may include “start” indicative of starting time of a period during which acceptance is possible and “end” indicative of ending time of the period during which acceptance is possible.

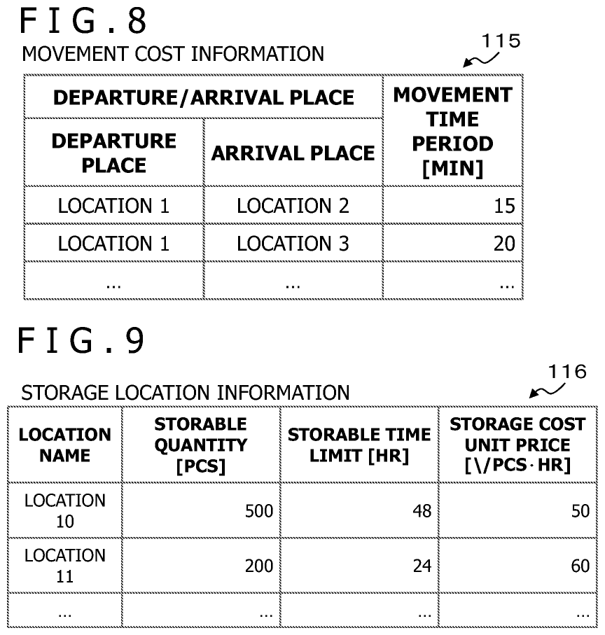

FIG. 8 is a view depicting an example of a data structure of the movement cost information 115 according to the working example 1.

The movement cost information 115 includes at least “departure place” for identifying a departure location of movement, “arrival place” for identifying an arrival location of the movement, and “movement time period” indicative of a time period required for the movement from the departure location to the arrival location.

FIG. 9 is a view depicting an example of a data structure of the storage location information 116 according to the working example 1.

The storage location information 116 includes at least “location name” for identifying a location, “storable quantity” indicative of the number of cargos storable at the location, “storage time limit” indicative of a time limit within which each cargo can be stored at each location, and “storage cost unit price” indicative of a cost per unit time required for storage of the cargos. The “storable quantity” may be substituted, for example, by “storable weight” indicative of a total weight of storable cargos, “storable volume” indicative of a total volume of storable cargos, a partial combination of “storable quantity,” “storable weight,” and “storable volume,” or “storable cargo amount” indicative of an amount of storable cargos.

Referring back to FIG. 3, in step S200, the storage place proposal generation section 121 divides a region that becomes a target of generation of a transportation plan (for example, a region including all locations included in the location information 113) into a plurality of divisional regions, by using the cargo information 111, the location information 113, the movement cost information 115, and the storage location information 116, taking the cargo amount collected and delivered at each of the locations and the distance between each location and the other locations into consideration. Then, the storage place proposal generation section 121 determines, in each of the divisional regions, storage locations each of which is short in distance to another divisional region and is high in storage capacity upper limit, as storage place candidates in the plan.

Here, the distance between a certain location (hereinafter referred to as a target location) in a certain divisional region and another divisional region can be calculated, for example, as an average of distances between the target location and the locations in the other divisional region or a distance between the target location and a location nearest to the target location in the other divisional region.

For example, where an evaluation value of each target location as a storage place is calculated by weighting operation in which the distance between the target location and each location in the other divisional region and a storage capacity upper limit of the target location are each weighted with a predetermined weight such that the evaluation value increases as at least one of the shortness level of the distance and the height of the storage capacity upper limit increases, the location at which the evaluation value is highest in each divisional region may be determined as a storage place candidate.

Further, the division into a plurality of divisional regions described above may be performed on the basis of an evaluation value indicative of an efficiency of transportation of cargos between divisional regions. For example, in a case where the amount of cargos to be transported from each divisional region to another divisional region is significantly small with respect to the loading capacity of a vehicle used for transportation (in other words, where the loading rate is significantly low), it is evaluated that the efficiency of transportation is low. Therefore, the evaluation value may be calculated such that the evaluation value increases on the basis of the loading rate of a vehicle that transports cargos from each divisional region to another divisional region increases, and a pattern of division which indicates a high evaluation value may be adopted. For example, the evaluation value may be calculated such that it increases as the loading rate increases or such that the evaluation value is high when the loading rate is higher than a predetermined reference value.

In step S300, by using at least one of the location information 113, the movement cost information 115, and the storage location information 116 as well as the cargo information 111 and the storage place candidates generated in step S200, the storage place proposal generation section 121 selects, for each cargo, storage place candidates from the storage place candidates determined in step S200 to generate a plurality of storage place proposals. For example, by using the movement cost information 115, the cargo information 111, and the storage place candidates generated in step S200, the storage place proposal generation section 121 generates, for each cargo, storage place proposals in which the cargo is transported via a storage place candidate at a location nearest to a collection source.

In step S400, by using the cargo information 111, the vehicle information 112, the location information 113, the movement cost information 115, the storage location information 116, and the storage place proposals generated in step S300, the storage place proposal generation section 121 adopts one storage place proposal for each cargo from the storage place proposals selected in step S300, taking the loading rate into consideration, to generate a plurality of storage place proposals for all cargos, and stores the generated storage place proposals into the storage place proposal information 117. The storage place proposals for all cargos are generated, for example, by full search.

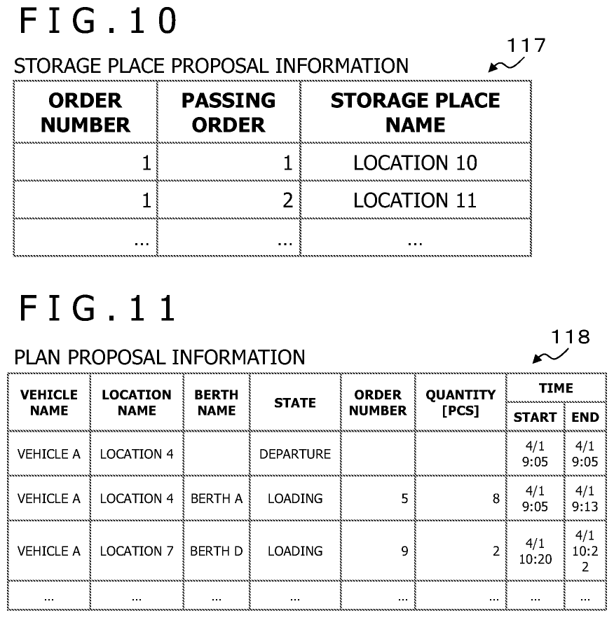

FIG. 10 is a view depicting an example of a data structure of the storage place proposal information 117 according to the working example 1.

The storage place proposal information 117 includes at least “order number” for identifying an order, “passing order” indicative of a sequential order in which a cargo of each order passes storage places, and “storage place name” indicative of a place in which a cargo of each order is stored during transportation. For example, the example of FIG. 10 depicts that a cargo of an order identified by the order number “1” is stored first at a storage place identified by “location 10” and then is stored at a storage place identified by “location 11.”

Referring back to FIG. 3, in step S500, by using the cargo information 111, the vehicle information 112, the location information 113, the movement cost information 115, the storage location information 116, and one of the storage place proposals for all cargos generated in step S400, the plan proposal generation section 122 generates a plurality of transportation schedule proposals for transporting each cargo such that the cargo is temporarily stored at a storage place designated by the storage place proposal with use of only available transportation resources and facilities, and places the generated transportation schedule proposals into the plan proposal information 118. Here, the plan proposal generation section 122 may plan transportation schedules including also plans for berths for performing loading and unloading, by additionally using the berth information 114. The transportation schedule proposals are generated, for example, by full search.

FIG. 11 is a view depicting an example of a data structure of the plan proposal information 118 according to the working example 1.

The plan proposal information 118 includes at least a plurality of transportation schedule proposals. Each of the transportation schedule proposals includes at least “vehicle name” for identifying a vehicle, “location name” for identifying a location of a transportation destination, a “berth name” for identifying a berth at which a work is to be performed, “state” indicative of a work to be performed at the location, “order number” indicative of an order of a working target, “quantity” indicative of the number of cargos of the order, and “time” indicative of time when the work is to be performed. The “quantity” may be substituted, for example, by “weight” indicative of a total weight of the cargos, “volume” indicative of a total volume of the cargos, a partial combination of “quantity,” “weight,” and “volume,” or “cargo amount” indicative of an amount of cargos. Further, “time” may include “start” indicative of starting date and time of a time zone in which the work is to be performed and “end” indicative of ending date and time of the time zone in which the work is to be performed.

Referring back to FIG. 3, in step S600, the plan evaluation section 123 performs a plan evaluation process using the cargo information 111, the vehicle information 112, and the storage location information 116, and one of the transportation schedule proposals generated in step S500.

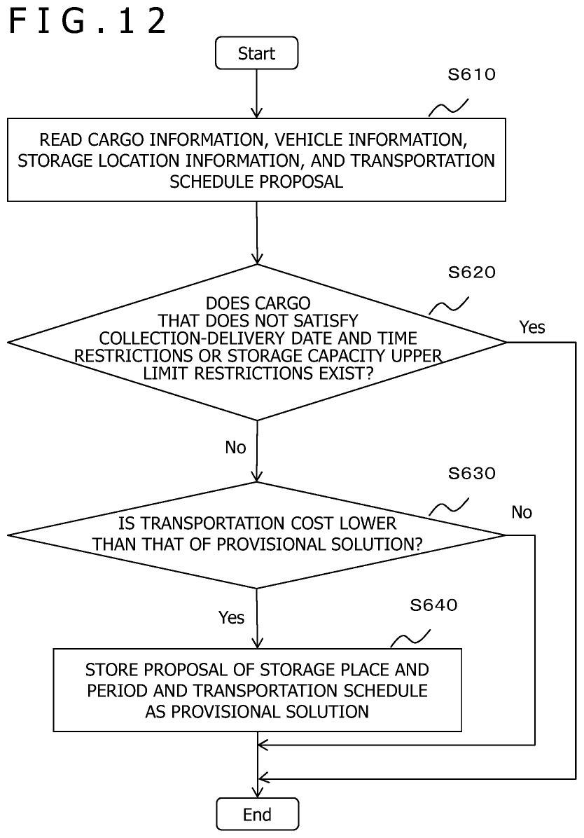

FIG. 12 is a flow chart depicting an example of the plan evaluation process performed by the plan evaluation section 123 according to the working example 1.

After the process is started, the plan evaluation section 123 reads the cargo information 111, the vehicle information 112, the storage location information 116, and one of the transportation schedule proposals stored in the plan proposal information 118, from the storage section 110 (S610).

In step S620, the plan evaluation section 123 determines whether or not a cargo that cannot be transported because it does not satisfy restrictions for collection date and time and delivery date and time or restrictions for a storage capacity upper limit exists in the transportation schedule proposal read from the plan proposal information 118.

Only when it is determined in step S620 that there does not exist a cargo that cannot be transported, the plan evaluation section 123 determines in step S630 whether or not the transportation cost is lower than that of the provisional solution. The transportation cost is calculated, for example, in accordance with the following expression (1).

[Math. 1]

Transportation cost=Vehicle fixed cost+Vehicle operation cost+Storage cost (1)

For example, the vehicle fixed cost, the vehicle operation cost, and the storage cost can be calculated in accordance with the following expressions (2), (3), and (4), respectively.

[Math. 2]

Vehicle fixed cost=Σ_{vehicle}(Number of vehicles×Vehicle unit price) (2)

[Math. 3]

Vehicle operation cost=Σ_{vehicle}(Total number of operating hours×Operation unit price) (3)

[Math. 4]

Storage cost=Σ_{cargo,location}(Quantity×Storage period×Storage cost unit price) (4)

Only when it is determined in step S630 that the transportation cost is lower than that of the provisional solution, the plan evaluation section 123 stores the transportation schedule proposal as a provisional solution in step S640.

Referring back to FIG. 3, finally in step S700, the transportation planning apparatus 100 outputs the provisional solution to the display section 140. Further, the communication section 150 transmits the transportation schedule to the in-vehicle terminal 200 and the plan management terminal 300 at each location through the network N.

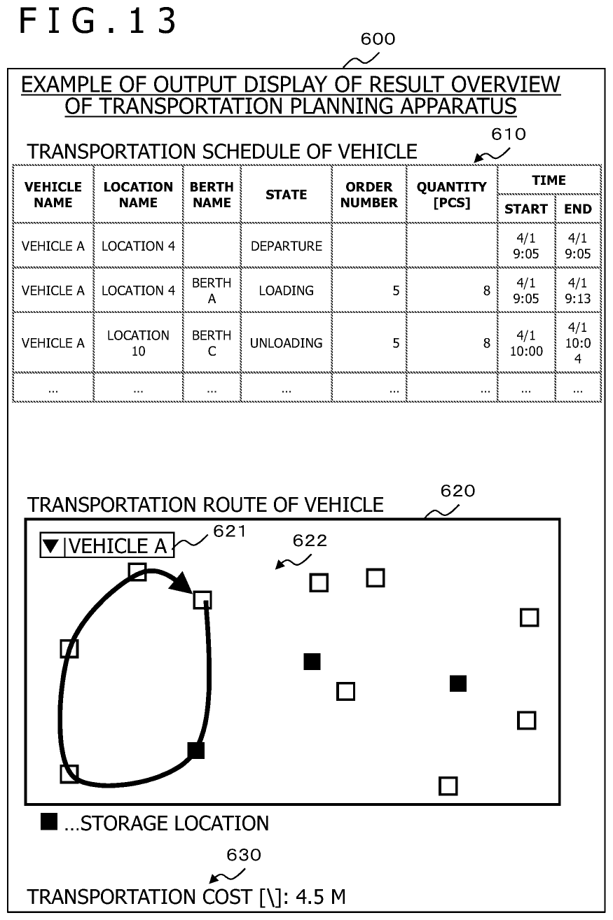

FIG. 13 is a view depicting an example of a display screen image 600 of a transportation schedule result overview of vehicles displayed on the display device 450 of the transportation planning apparatus 100 according to the working example 1.

The display screen image 600 includes a display area 610 for a transportation schedule of a vehicle, a display area 620 for a transportation route of a vehicle or vehicles, and a display area 630 for a transportation cost. The user can easily acquire the transportation schedule and confirm the transportation cost by referring to the display screen image 600.

In the display area 610 for a transportation schedule of a vehicle, a transportation schedule of a vehicle that requires a minimum transportation cost is displayed. In particular, for example, a transportation vehicle, a location name of a location at which a work is to be performed, a berth name of a berth at which the work is to be performed, a state of the work, an order number of a working target, and time when the work is to be performed are displayed. Further, a transportation amount of the order may be displayed.

The state of the work can be at least one of departure, loading, unloading, and arrival. As the transportation amount, for example, the quantity, weight, or volume of cargos of an order or a combination of them can be used. Further, the time may include starting date and time and ending date and time for performing the work. The time may be substituted by a period of time for which the vehicle is to stay at the location. The transportation schedule may be visualized by use of such a Gantt chart that the axis of abscissa indicates time and the axis of ordinate indicates vehicles (not depicted). Since the transportation schedule includes location names, order numbers, and time for which the work is to be performed, a storage place and period for each cargo can be read from the transportation schedule.

In the display area 620 for a transportation route of a vehicle or vehicles, a button 621 for selecting a transportation route for each vehicle or transportation routes for all vehicles and a transportation route 622, on a map, of a vehicle or vehicles selected by the button 621 are displayed. In the example of FIG. 13, a transportation route for a vehicle A is selectively displayed. In a case where the latitude and the longitude of the locations are stored in the location information 113, each of the locations is displayed according to the latitude and the longitude. Further, a location that is used for storage in the transportation schedule is displayed in a manner distinct from the other locations. In FIG. 13, locations used for storage are indicated by black quadrangles, and the other locations are indicated by white quadrangles.

In the display area 630 for a transportation cost, a total transportation cost is displayed. Expenses required for transportation resources such as the vehicle cost, the labor cost incurred for drivers and so forth, and expenses required for storage may be displayed additionally.

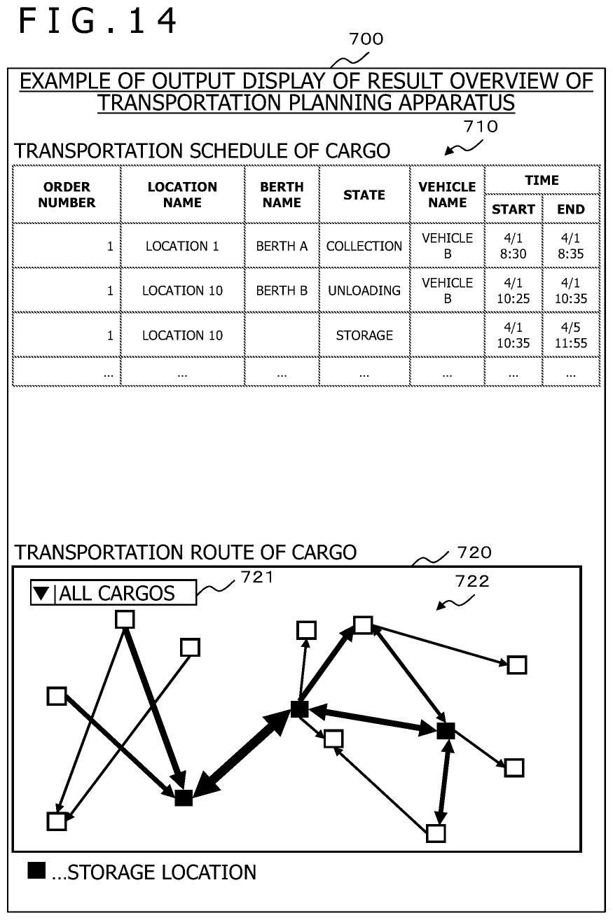

FIG. 14 is a view depicting an example of a display screen image 700 of a transportation schedule result overview of cargos displayed on the display device 450 of the transportation planning apparatus 100 according to the working example 1.

The display screen image 700 includes a display area 710 for a transportation schedule of a cargo and a display area 720 for a transportation route of a cargo or cargos. The user can easily acquire storage places and storage periods by referring to the display screen image 700.

In the display area 710 for a transportation schedule of a cargo, a transportation schedule for a cargo in which the transportation cost is in the minimum is displayed. In particular, for example, an order number of a working target, a location name of a location at which the work is to be performed, a berth name of a berth at which the work is to be performed, a state of the work, a vehicle name of a vehicle used for loading and unloading a cargo of the order, and time for performing the work are displayed. The state of the work can be at least one of collection, unloading, storage, loading, and delivery. Further, a transportation amount of the order may be displayed. As the transportation amount, for example, the quantity, weight, or volume of the cargo or a combination of them can be used. Further, the time may include starting date and time and ending date and time for performing the work. The transportation schedule may be visualized by use of such a Gantt chart that the axis of abscissa indicates time and the axis of ordinate indicates vehicles (not depicted).

In the display area 720 for a transportation route of a cargo or cargos, a button 721 for selecting a transportation route for each cargo or transportation routes for all cargos and a transportation route 722, on a map, of a cargo or cargos selected by operation of the button 721 by the user are displayed. In the example of FIG. 14, the transportation routes for all cargos are selected and displayed. The displaying method of each location is same as that in the display area 620 for a transportation route of a vehicle or vehicles.

In the example of FIG. 14, an arrow mark that interconnects locations indicates that a cargo is transported between the locations. The direction of the arrow mark indicates a direction in which a cargo is transported, and a double-sided arrow mark indicates that, along the transportation route, one cargo is transported in one direction and another cargo is transported in the opposite direction. Further, the thickness of the arrow mark indicates the transportation amount.

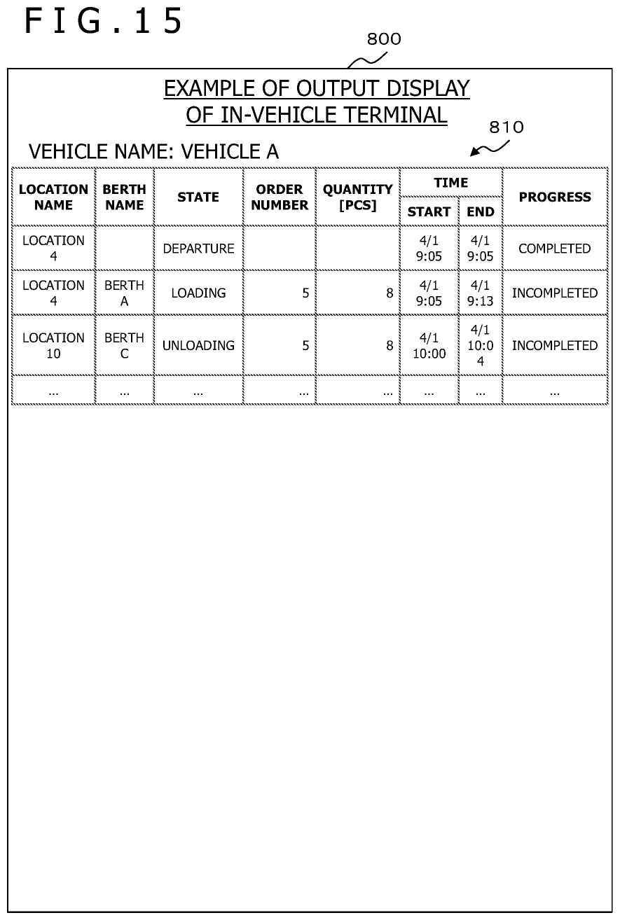

FIG. 15 is a view depicting an example of a display screen image 800 of the in-vehicle terminal 200 according to the working example 1.

On the display screen image 800, a transportation schedule 810 of the vehicle 510 is displayed. In particular, as the transportation schedule 810 of the vehicle 510, for example, in addition to display items similar to those in the display area 610 for a transportation schedule of a vehicle, information indicative of a progress situation of a transportation work of the cargo by the vehicle (for example, whether or not the transportation work is completed) is displayed. The display screen image 800 makes it possible for a driver of each vehicle to confirm a transportation schedule the driver is to follow and a progress situation of the transportation by the vehicle driven by the driver.

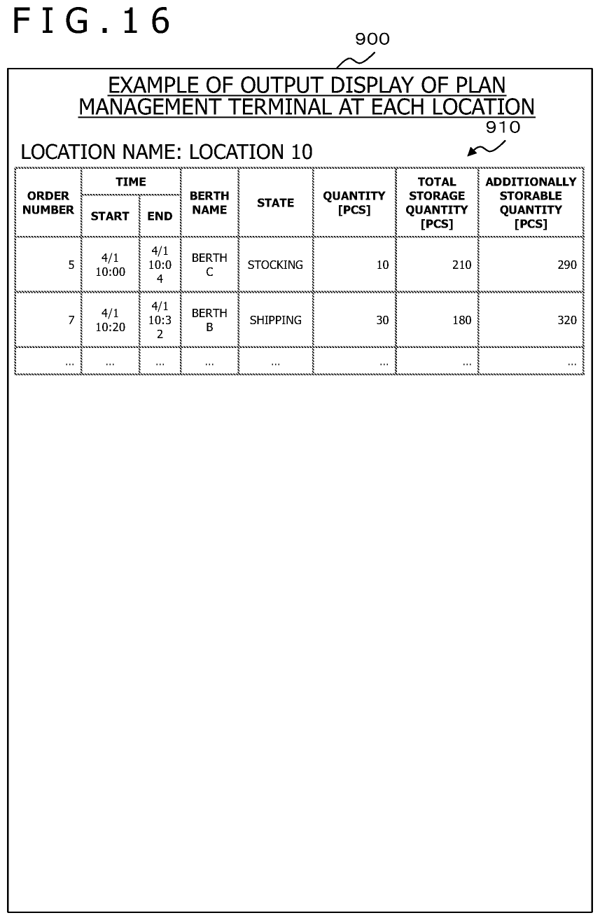

FIG. 16 is a view depicting an example of a display screen image 900 of the plan management terminal 300 at each location according to the working example 1.

On the display screen image 900, a schedule 910 for transportation related works performed in the collection, delivery, and storage facility 520 is displayed. In particular, as the schedule 910 for transportation related works to be performed in the collection, delivery, and storage facility 520, for example, an order number of a work target, time to perform a work, a berth name of a berth at which the work is to be performed, and a state of the work are displayed. The state of the work can be at least one of collection, delivery, shipping, and stocking. On the display screen image 900, a transportation amount of the order may further be displayed. As the transportation amount, for example, the quantity, weight, or volume of cargos or a combination of them can be used. Further, the time may include starting date and time and ending date and time for performing the work. In the case of a storage location, the display screen image 900 may further include a total storage amount and an additionally storable amount of cargos. As the total storage amount, for example, the total storage quantity, total storage weight, or total storage volume of cargos or a combination of them can be used. Also for the additionally storable amount, for example, the additionally storable quantity, additionally storable weight, or additionally storable volume of cargos or a combination of them can be used similarly. By referring to the display screen image 900, a person in charge of planning and operation and a worker at each location can confirm the schedule of transportation related works to be performed at the location.

It is to be noted that, in the present working example, as a result of the process in FIG. 12, one transportation schedule proposal that indicates the lowest transportation cost is outputted as an optimum proposal in step S700 of FIG. 13. However, such a method as just described is merely an example, and another method may be adopted as a method for selecting an optimum transportation schedule proposal on the basis of calculated transportation costs. For example, the transportation planning apparatus 100 may output several transportation schedule proposals in an ascending order of the transportation cost, so that the user can select one of them. At this time, the transportation planning apparatus 100 may output a plurality of transportation schedule proposals each of which indicates a transportation cost lower than a predetermined criterion. Alternatively, the transportation planning apparatus 100 may select, from a plurality of transportation schedule proposals that indicate a low transportation cost, one transportation schedule proposal on the basis of a different evaluation index.

### WORKING EXAMPLE 2

In the following, a working example 2 of the present invention is described. In the present working example, the plan evaluation section 123 evaluates the transportation cost including the labor cost. Except differences described below, the components of the system of the working example 2 have functions same as those of the components denoted by identical reference symbols in the working example 1 depicted in FIGS. 1 to 16, and therefore, description of them is omitted herein.

The storage section 110 of the working example 2 stores, in addition to the information stored in the storage section 110 of the working example 1, driver information 161 that is information regarding drivers who carry out transportation and worker information 162 that is information regarding workers who carry out loading and unloading works.

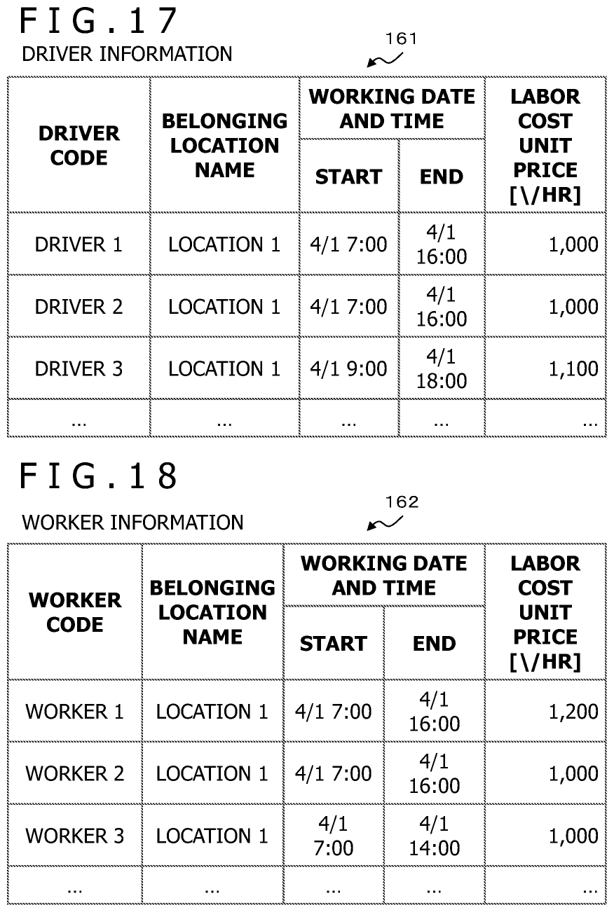

FIG. 17 is a view depicting an example of a data structure of the driver information 161 according to the working example 2.

The driver information 161 includes at least “driver code” for identifying a driver, “belonging location name” indicative of a name of a location to which the driver belongs, “working date and time” indicative of date and time when the driver can work, and “labor cost unit price” indicative of a labor cost per hour required for the driver. The “working date and time” may include “start” indicative of starting date and time of a period during which the driver can work and “end” indicative of ending date and time of the period during which the driver can work. Further, the “working date and time” may be substituted by “working time period upper limit” indicative of an upper limit of a possible continuous work time period per day, or “working date and time” and “working time period upper limit” may be combined.

FIG. 18 is a view depicting an example of a data structure of the worker information 162 according to the working example 2.

The worker information 162 includes at least “worker code” for identifying a worker, “belonging location name” indicative of a name of a location at which the worker works, “working date and time” indicative of date and time when the worker can work, and “labor cost unit price” indicative of a labor cost per hour required for the worker. The “working date and time” may include “start” indicative of starting date and time of a period during which the worker can work and “end” indicative of ending date and time of the period during which the worker can work. Further, the “working date and time” may be substituted by “working time period upper limit” indicative of an upper limit of a possible continuous work time period per day, or “working date and time” and “working time period upper limit” may be combined.

Subsequently, differences of the process of the transportation planning apparatus 100 of the working example 2 from that described in connection with the working example 1 are described.

In step S100 of FIG. 3, the storage section 110 of the working example 2 reads the driver information 161 and the worker information 162, in addition to the information described hereinabove in connection with the working example 1, from the inputting device 460.

In step S610 of FIG. 12, the plan evaluation section 123 of the working example 2 reads the driver information 161 and the worker information 162, in addition to the information described hereinabove in connection with the working example 1, from the storage section 110.

In step S630 of FIG. 12, the plan evaluation section 123 of the working example 2 performs allocation of drivers and workers on the basis of the transportation schedule proposal, the driver information 161, and the worker information 162 and determines whether or not the transportation cost including the labor cost is lower than that of the provisional solution. The labor cost is calculated, for example, by summation of the driver labor cost and the worker labor cost. For example, the driver labor cost and the worker labor cost can be calculated by the following expressions (5) and (6), respectively.

[Math. 5]

Driver labor cost=Σ_{driver}(Working hours×Labor cost unit price) (5)

[Math. 6]

Worker labor cost=Σ_{worker}(Working hours×Labor cost unit price) (6)

The transportation planning systems according to the working examples of the present invention have been described. According to each of the transportation planning systems described above, a transportation schedule including a daily plan for a storage place and period of each cargo can be made, for cargos for a period designated by a user, such that the transportation cost is reduced within the capacity of the storage places and resources.

The system of an embodiment of the present invention may also be configured in the following manner.

(1) A transportation planning system (for example, the transportation planning system 1) includes a control section (for example, the control section 120) and a storage section (for example, the storage section 110) connected to the control section. The storage section retains cargo information (for example, the cargo information 111) indicative of a transportation source, a transportation destination, and a transportation amount of cargos based on an order, vehicle information (for example, the vehicle information 112) indicative of a loading capacity and a cost of each of a plurality of vehicles that can be used for transportation of the cargos, location information (for example, the location information 113) indicative of positions of a plurality of locations at each of which at least one of loading of the cargos into the vehicles, unloading of the cargos from the vehicles, and storage of the cargos is to be performed, movement time period information (for example, the movement cost information 115) indicative of a time period required for movement between the locations, and storage location information (for example, the storage location information 116) indicative of an amount of cargos that can be stored and a storage cost at each of locations at which the cargos can be stored among the plurality of locations. The control section divides a region including the plurality of locations into a plurality of divisional regions each including one or more of the locations (for example, step S200), selects one or more of the locations in each of the plurality of divisional regions as a candidate or candidates for a storage location of the cargos (for example, step S200), and generates a plurality of transportation schedules each including a plan of the candidate or candidates for a storage location and of a storage period for storing each of the cargos on the basis of the cargo information, the vehicle information, the location information, and the movement time period information (for example, steps S300, S400, and S500). The control section further determines, on the basis of the storage location information, that, in a case where an amount of cargos to be stored at the candidate or candidates for a storage location of the cargos in each of the plurality of transportation schedules does not exceed the amount of cargos that can be stored at the corresponding location, the plan of the candidate or candidates for a storage location and of the storage period included in the transportation schedule is reasonable (for example, step S620), and calculates a transportation cost in one or more of the transportation schedules for which it has been determined that the plan of the candidate or candidates for a storage location and of the storage period is reasonable, on the basis of the vehicle information, the location information, the movement time period information, and the storage location information (for example, step S630).

This can reduce the transportation cost in transportation of cargos including a cargo that requires temporary storage between collection and delivery.

(2) In the (1) above, the storage section further retains berth information (for example, the berth information 114) indicative of time when a berth can be used at each of the locations, and the control section generates the transportation schedules each including information for identifying a berth to be used at each of the locations (for example, step S500).

This makes it possible to generate a transportation schedule with high accuracy.

(3) In the (1) above, the control section calculates an evaluation value of an efficiency of transportation of the cargos on the basis of at least one of an amount of the cargos to be transported between the divisional regions and a distance between the locations, and divides the region including the plurality of locations into a plurality of divisional regions such that the evaluation value becomes high.

This makes it possible to generate a transportation schedule in accordance with which transportation with high efficiency is performed.

(4) In the (3) above, the control section calculates a loading rate on the basis of the amount of the cargos to be transported between the divisional regions and a loading amount upper limit of the vehicles and increases the evaluation value on the basis of height of the loading rate.

This makes it possible to perform division of a region such that transportation with high efficiency is performed.

(5) In the (1) above, the control section calculates an evaluation value for each of the one or more locations included in each of the divisional regions such that the evaluation value increases as at least one of a shortness level in distance from the location to another one of the divisional regions and an amount of the cargos that can be stored at the location increases, and selects a location or locations at which the evaluation value is high as a candidate or candidates for a storage location.

This makes it possible to generate a transportation schedule in accordance with which transportation with high efficiency is performed.

(6) In the (1) above, the storage section further retains driver information (for example, the driver information 161) indicative of a working time period and a cost of drivers of the vehicles and worker information (for example, the worker information 162) indicative of a working time period and a cost of a worker at each of the locations, and the control section calculates a transportation cost in one or more of the transportation schedules for which it has been determined that the plan of the candidate or candidates for a storage location and of the storage period is reasonable, on the basis of the vehicle information, the location information, the movement time period information, the storage location information, the driver information, and the worker information (for example, step S630).

This makes it possible to calculate a transportation cost with high accuracy.

(7) In the (1) above, the control section outputs a transportation schedule in which the transportation cost is lowest among the one or more of the transportation schedules for which it has been determined that the plan of the candidate or candidates for a storage location and of the storage period is reasonable (for example, steps S630, S640, and S700).

This can reduce the transportation cost.

(8) In the (7) above, the transportation planning system further includes a display section (for example, the display section 140) connected to the control section, and the display section displays the transportation schedule in which the transportation cost is lowest.

This can implement transportation based on the transportation schedule proposal in which the transportation cost is low.

(9) In the (7) above, the transportation planning system further includes a plurality of in-vehicle terminals (for example, the in-vehicle terminals 200) and a plurality of plan management terminals (for example, the plan management terminals 300) both connected to the control section through a network. The plurality of in-vehicle terminals are installed in the plurality of vehicles, and the plurality of plan management terminals manage a work plan at the plurality of locations. The control section outputs the transportation schedule in which the transportation cost is lowest to the plurality of in-vehicle terminals and the plurality of plan management terminals (for example, step S700). Each of the in-vehicle terminals outputs information regarding a vehicle on which the in-vehicle terminal is mounted (for example, the transportation schedule 810 of a vehicle), from the information included in the transportation schedule acquired from the control section. Each of the plan management terminals outputs information regarding a location at which the plan management terminal manages the work plan (for example, the schedule 910 of a transportation related work), from the information included in the transportation schedule acquired from the control section.

This can implement transportation based on the transportation schedule proposal in which the transportation cost is low.

It is to be noted that the present invention is not limited to the working examples described hereinabove and includes various modifications. For example, the above working examples have been described in detail for better understandings of the present invention, and the present invention is not necessarily restricted to one that includes all components described hereinabove. Further, it is possible to replace part of the components of a certain working example with components of another working example, and it is also possible to add a component of a certain working example to the components of another working example. Further, it is possible to add or delete a certain component to or from part of the components of the working examples, or replace part of the components of the working examples with another component.

Further, the components, functions, processing sections, processing means, and so forth described hereinabove may be partly or entirely implemented by hardware by designing them, for example, in an integrated circuit. Further, the components, functions, and so forth described above may be implemented by software by causing a processor to interpret and execute programs for implementing them. Information of programs, tables, files, and so forth for implementing the functions can be stored into a storage device such as a nonvolatile semiconductor memory, a hard disk drive, or a solid state drive (SSD) or a computer-readable non-transitory data storage medium such as an integrated circuit (IC) card, a secure digital (SD) card, or a digital versatile disc (DVD).

Further, control lines and information lines are depicted in the drawings where they are considered necessary for description of the working examples, and all of the control lines and information lines that are actually necessary in products are not necessarily depicted. Actually, it may be considered that almost all components are connected to each other.

What is claimed is:

1. A transportation planning system comprising:
a control section; and
a storage section connected to the control section, wherein
the storage section retains
cargo information indicative of a transportation source, a transportation destination, and a transportation amount of cargos based on an order,
vehicle information indicative of a loading capacity and a cost of each of a plurality of vehicles that can be used for transportation of the cargos,
location information indicative of positions of a plurality of locations at each of which at least one of loading of the cargos into the vehicles, unloading of the cargos from the vehicles, and storage of the cargos is to be performed,
movement time period information indicative of a time period required for movement between the locations, and
storage location information indicative of an amount of cargos that can be stored and a storage cost at each of locations at which the cargos can be stored among the plurality of locations, and
the control section
divides a region including the plurality of locations into a plurality of divisional regions each including one or more of the locations,
selects one or more of the locations in each of the plurality of divisional regions as a candidate or candidates for a storage location of the cargos,
generates a plurality of transportation schedules each including a plan of the candidate or candidates for a storage location and of a storage period for storing each of the cargos on a basis of the cargo information, the vehicle information, the location information, and the movement time period information,
determines, on a basis of the storage location information, that, in a case where an amount of cargos to be stored at the candidate or candidates for a storage location of the cargos in each of the plurality of transportation schedules does not exceed the amount of cargos that can be stored at the corresponding location, the plan of the candidate or candidates for a storage location and of the storage period included in the transportation schedule is reasonable, and
calculates a transportation cost in one or more of the transportation schedules for which it has been determined that the plan of the candidate or candidates for a storage location and of the storage period is reasonable, on a basis of the vehicle information, the location information, the movement time period information, and the storage location information.

2. The transportation planning system according to claim 1, wherein
the storage section further retains berth information indicative of time when a berth can be used at each of the locations, and
the control section generates the transportation schedules each including information for identifying a berth to be used at each of the locations.

3. The transportation planning system according to claim 1, wherein
the control section calculates an evaluation value of an efficiency of transportation of the cargos on a basis of at least one of an amount of the cargos to be transported between the divisional regions and a distance between the locations, and divides the region including the plurality of locations into a plurality of divisional regions such that the evaluation value becomes high.

4. The transportation planning system according to claim 3, wherein
the control section calculates a loading rate on a basis of the amount of the cargos to be transported between the divisional regions and a loading amount upper limit of the vehicles and increases the evaluation value on a basis of height of the loading rate.

5. The transportation planning system according to claim 1, wherein
the control section calculates an evaluation value for each of the one or more locations included in each of the divisional regions such that the evaluation value increases as at least one of a shortness level in distance from the location to another one of the divisional regions and an amount of the cargos that can be stored at the location increases, and selects a location or locations at which the evaluation value is high as a candidate or candidates for a storage location.

6. The transportation planning system according to claim 1, wherein
the storage section further retains driver information indicative of a working time period and a cost of drivers of the vehicles and worker information indicative of a working time period and a cost of a worker at each of the locations, and
the control section calculates a transportation cost in one or more of the transportation schedules for which it has been determined that the plan of the candidate or candidates for a storage location and of the storage period is reasonable, on a basis of the vehicle information, the location information, the movement time period information, the storage location information, the driver information, and the worker information.

7. The transportation planning system according to claim 1, wherein
the control section outputs a transportation schedule in which the transportation cost is lowest among the one or more of the transportation schedules for which it has been determined that the plan of the candidate or candidates for a storage location and of the storage period is reasonable.

8. The transportation planning system according to claim 7, further comprising:
a display section connected to the control section, wherein
the display section displays the transportation schedule in which the transportation cost is lowest.

9. The transportation planning system according to claim 7, further comprising:
a plurality of in-vehicle terminals and a plurality of plan management terminals both connected to the control section through a network, wherein
the plurality of in-vehicle terminals are installed in the plurality of vehicles,
the plurality of plan management terminals manage a work plan at the plurality of locations,
the control section outputs the transportation schedule in which the transportation cost is lowest to the plurality of in-vehicle terminals and the plurality of plan management terminals,
each of the in-vehicle terminals outputs information regarding a vehicle on which the in-vehicle terminal is mounted, from the information included in the transportation schedule acquired from the control section, and
each of the plan management terminals outputs information regarding a location at which the plan management terminal manages the work plan, from the information included in the transportation schedule acquired from the control section.

10. A transportation planning method executed by a transportation planning system that includes a control section and a storage section connected to the control section,
the storage section retaining
cargo information indicative of a transportation source, a transportation destination, and a transportation amount of cargos based on an order,
vehicle information indicative of a loading capacity and a cost of each of a plurality of vehicles that can be used for transportation of the cargos,
location information indicative of positions of a plurality of locations at each of which at least one of loading of the cargos into the vehicles, unloading of the cargos from the vehicles, and storage of the cargos is to be performed,
movement time period information indicative of a time period required for movement between the locations, and
storage location information indicative of an amount of cargos that can be stored and a storage cost at each of locations at which the cargos can be stored among the plurality of locations,
the transportation planning method comprising:
by the control section, a step of dividing a region including the plurality of locations into a plurality of divisional regions each including one or more of the locations;
by the control section, a step of selecting one or more of the locations in each of the plurality of divisional regions as a candidate or candidates for a storage location of the cargos;
by the control section, a step of generating a plurality of transportation schedules each including a plan of the candidate or candidates for a storage location and of a storage period for storing each of the cargos on a basis of the cargo information, the vehicle information, the location information, and the movement time period information;
by the control section, a step of determining, on a basis of the storage location information, that, in a case where an amount of cargos to be stored at the candidate or candidates for a storage location of the cargos in each of the plurality of transportation schedules does not exceed the amount of cargos that can be stored at the corresponding location, the plan of the candidate or candidates for a storage location and of the storage period included in the transportation schedule is reasonable; and
by the control section, a step of calculating a transportation cost in one or more of the transportation schedules for which it has been determined that the plan of the candidate or candidates for a storage location and of the storage period is reasonable, on a basis of the vehicle information, the location information, the movement time period information, and the storage location information.
